(19) United States
(12) Patent Application Publication
(10) Pub. No.: US 2008/0106393 A1
(43) Pub. Date: May 8, 2008

(54) Vehicle surveillance system

(76) Inventors: Linda Bedell, Tallahassee, FL (US); Thedrick A. Walker, Tallahassee, FL (US)

Correspondence Address: John Wiley Horton;Pennington, Moore, Wilkinson, Bell & Dunbar, P.A., 2nd Floor, 215 S. Monroe St., Tallahassee, FL, 32301, US

(21) Appl. No.: 11/591,860

(22) Filed: Nov. 2, 2006

(51) Int. Cl. H04N 7/18

(52) U.S. Cl. 340/438; 348/148; 348/E07.091

(57) ABSTRACT

A security system for monitoring activities occurring within a vehicle. The security system includes a video camera and microphone which are positioned to monitor activities occurring within said vehicle. A receiver receives video and sound data from the video camera and stores the data in its hard drive. The receiver includes a recording means configured to record the video data to the hard drive. A data port is provided on the receiver and is electronically connected to the hard drive. The data port may be a USB type data port. An external memory unit, such as a jump drive is also provided for transferring memory from the hard drive to another location. The receiver includes an external memory unit detecting means configured to detect whenever the external memory unit is connected to the data port.

### BACKGROUND OF THE INVENTION

1. Field of the Invention

This invention relates to the field of vehicular security systems. More specifically, this invention comprises a vehicle surveillance system having data recording and data transferring capabilities.

2. Description of the Related Art

Vehicular security systems seek to protect the owner of a vehicle from theft or occupants of a vehicle from hijacking. Various security systems and devices are currently used for such purposes, including car alarm systems, “panic” type transmitters, automobile demobilization systems, and GPS tracking systems. Although these systems and devices serve useful purposes, there remains a need for a system that would allow law enforcement to easily determine the identity of a thief or hijacker so that the thief or hijacker may be apprehended.

There is also a need for a system for monitoring “at-risk” individuals when they are driving or riding in a vehicle. For example, many parents desire the ability to monitor their children's driving when the parents are not present in the vehicle. Also, governmental agencies have a need to monitor individuals convicted of certain offenses, particularly when these convicted individuals are driving. In addition, school systems desire the ability to better monitor the conduct of their bus-riding students to prevent bullying and other disruptive behaviors that endanger the safety of the students.

It is therefore desirable to provide a security system for a vehicle which is capable of the previously described monitoring functions. It is also desirable for the security system to be capable of transferring video and/or audio data of activities occurring in the vehicle.

### BRIEF SUMMARY OF THE INVENTION

The present invention is a security system for monitoring activities occurring within a vehicle. The security system includes a video camera and microphone which are positioned to monitor activities occurring within said vehicle. In one embodiment the video camera is attached to the rearview mirror and the microphone is attached to the top liner in the cabin.

A receiver is also provided. The receiver receives video and sound data from the video camera and stores the data in its hard drive. The receiver may be placed in the trunk or another secure location. The receiver includes a recording means configured to record the video data to the hard drive. A data port is provided on the receiver and is electronically connected to the hard drive. The data port may be a USB (“Universal Serial Bus”) type data port. An external memory unit, such as a jump drive, is also provided for transferring memory from the hard drive to another location. The receiver includes an external memory unit detecting means configured to detect whenever the external memory unit is connected to the data port. The external memory unit detecting means and the recording means may both be provided as software or firmware in the receiver.

In the preferred embodiment, the receiver also includes a transmitter configured to wirelessly transmit data to a remote location. For example, the transmitter may transmit the data to a receiver on a personal computer.

### BRIEF DESCRIPTION OF THE SEVERAL VIEWS OF THE DRAWINGS

FIG. 1 is a side view, illustrating the present invention installed in a vehicle.

FIG. 2 is a schematic, illustrating the present invention.

FIG. 3 is a side view, illustrating a receiver.

FIG. 4 is a schematic, illustrating the present invention.

### REFERENCE NUMERALS IN THE DRAWINGS

| | | | |
|---|---|---|---|
| 10 | car | 12 | video camera |
| 14 | microphone | 16 | receiver |
| 18 | computer | 20 | encoder/compressor |
| 22 | data port | 24 | transmitter |
| 26 | audio inputs | 28 | video input |
| 30 | encode step | 32 | compress step |
| 34 | write step | 36 | transmit step |
| 38 | determination step | 40 | delete step |
| 42 | record step | 44 | download step |
| 46 | detect key step | 48 | detect USB step |
| 50 | delete step | 52 | hard drive |
| 54 | recording indicator LED | 56 | memory indicator LED |
| 58 | data transfer indicator LED | | |

### DETAILED DESCRIPTION OF THE INVENTION

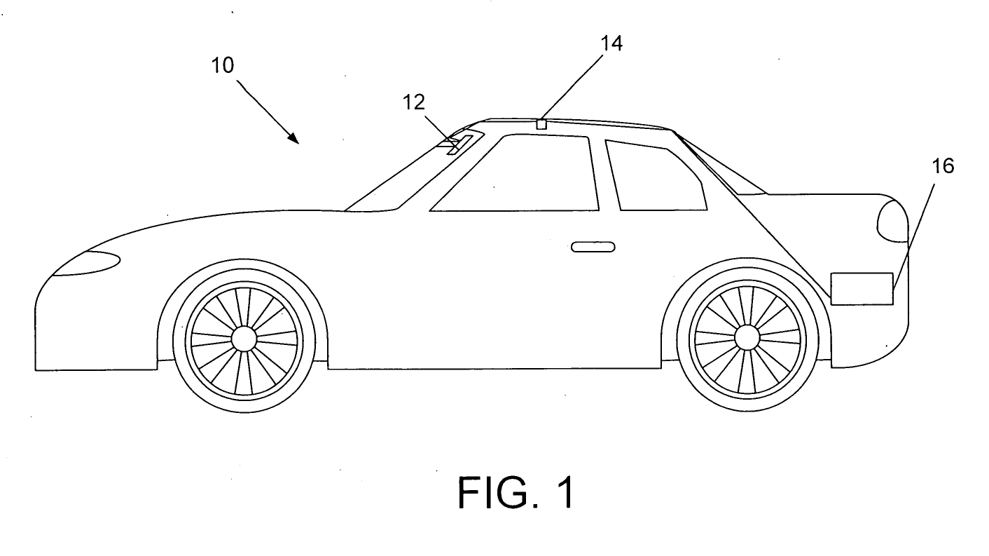

The present invention, a vehicle security system, is illustrated in FIG. 1. Car 10 is equipped with video camera 12 and microphone 14. Video camera 12 is positioned in an orientation to monitor the activities occurring within the cabin of car 10. In the current example, video camera 12 is integrated with the rearview mirror of car 10 such that the lens of video camera 12 faces the occupants of the vehicle. Video camera 12 could also be positioned in a different location in car 10 or multiple video cameras may be used, with each camera having a different viewing angle of car 10. Microphone 14 is attached to the liner material on the top of the cabin so that it may pick up sounds from the front seats and back seats of the car. Microphone 14, like video camera 12, may be placed in other locations as well.

Microphone 14 and video camera 12 are electronically connected to receiver 16. Receiver 16 is placed in a secure location in car 10. In the present example, receiver 16 is placed in the trunk of the vehicle. Receiver 16 records and transmits video and sound data transmitted to receiver 16 from video camera 12 and microphone 14, respectively.

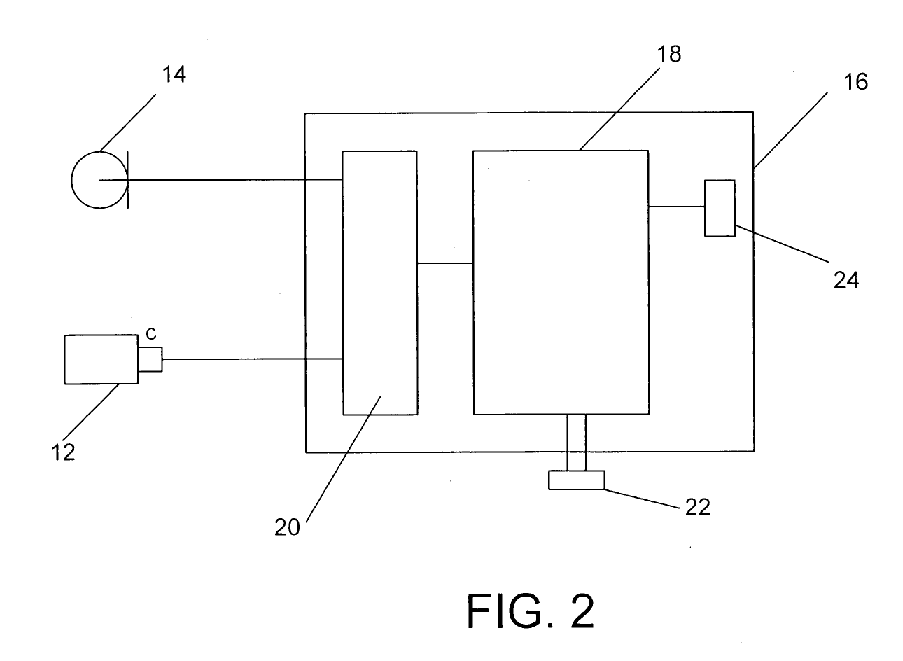

As illustrated in FIG. 2, microphone 14 transmits sound data to receiver 16 where it is compressed by encoder/compressor 20. Video camera 12 transmits video data to receiver 16 where it is encoded by encoder/compressor 20. Encoded and compressed video and sound data is then transmitted to computer 18. Computer 18 includes a hard drive for storing the video and sound data. Computer 18 also includes software of firmware which directs receiver 18 to perform its various functions and operations. In particular, computer 18 includes a recording means configured to record the video data to the hard drive and an external memory unit detecting means configured to detect whenever an external memory unit is connected to data port 22. Data port 22 is provided on the exterior of receiver 16 and is electronically connected to the hard drive. In the preferred embodiment, data port 22 is a USB (“Universal Serial Bus”) type data port. An external memory unit, such as a jump drive is also provided for transferring memory from the hard drive to another location. The external memory unit detecting and recording operations may both be controlled and directed by software or firmware in contained in computer 18.

Receiver 16 also includes transmitter 24 which is configured to wirelessly transmit video and sound feed to a remote location. For example, transmitter 24 may transmit the data to a receiver on a personal computer. Transmitter 24 may transmit “live” video and/or sound feed utilizing various wireless transmission media that are known in the art. In one embodiment, receiver 16 may wirelessly transmit the data via satellite, GPRS (General Packet Radio Service), cellular or radio signals.

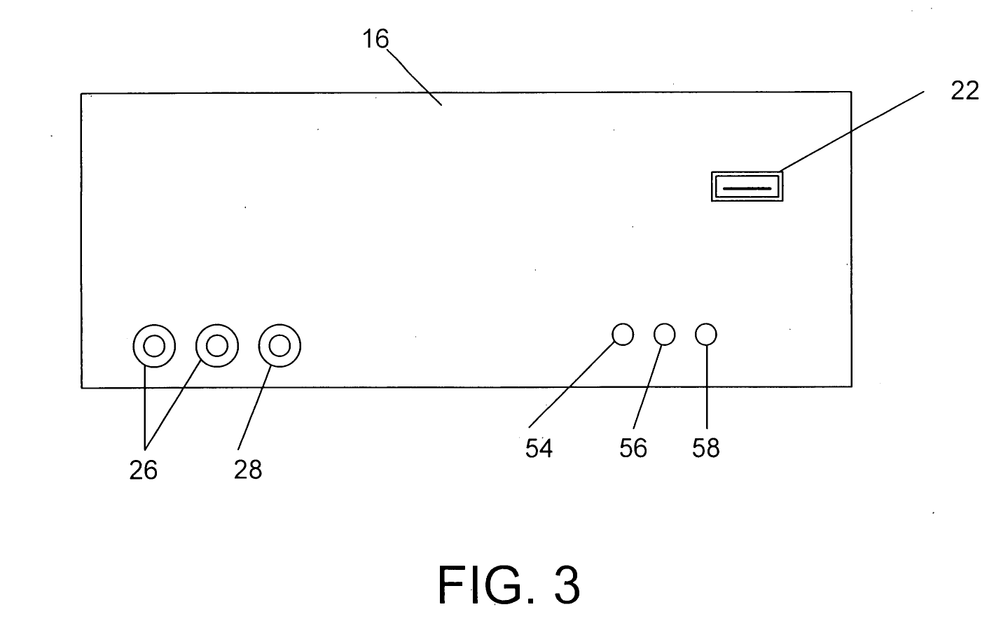

FIG. 3 shows a side view of receiver 16. Receiver 16 includes jacks for audio inputs 26 and video input 28. The type of input jacks used will obviously depend upon the type of video camera and microphone that is used. Receiver 16 also includes data port 22 which is configured to receive the external memory unit. Although it is not illustrated, receiver 16 also includes a power supply cord. Receiver 16 may draw power from car 10 or an auxiliary power source.

A series of LED lights are provided on the side of receiver 16 to provide status information to the user. Recording indicator LED 54 is on when receiver 16 is recording video and/or sound data to its hard drive. Memory indicator LED 56 is on when the amount of data stored in the hard drive is nearing the capacity of the hard drive. Memory indicator LED 56 may be set to turn on at any predefined memory usage threshold, however. Data transfer indicator LED 58 is on when data is being transferred from the hard drive to the external memory unit. Data transfer indicator LED 58 turns off when the transfer is complete.

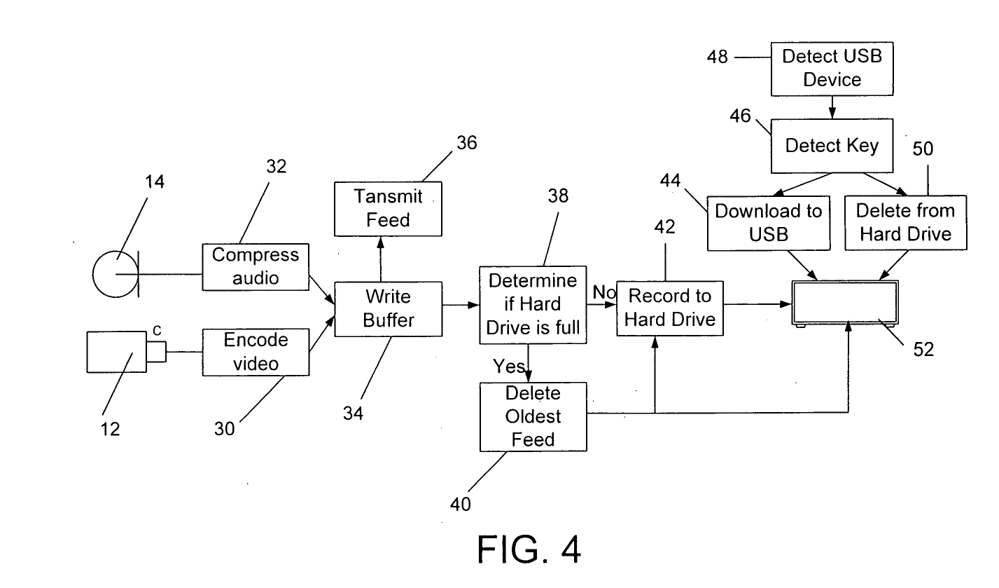

A schematic illustrating operation of the present invention is provided in FIG. 4. Audio data from microphone 14 is compressed, as indicated by compress step 32. Video data from video camera 12 is encoded concurrently with the compression of audio data, as indicated by encode step 30. A buffer is then written which combines the encoded video and compressed audio, as indicated by write step 34. This “feed” may be transmitted “live” wirelessly as indicated by transmit step 36. Simultaneous to the live transmission, the computer in the receiver determines whether hard drive 52 is full or contains a predefined threshold of video and/or audio data as indicated by determination step 38. Determination step 38 is iteratively performed at predefined time intervals during the recording process. If it is determined that the hard drive is full or contains the predefined threshold quantity of data, a portion of the oldest data is deleted, as indicated by delete step 40. The portion of data that is deleted may correspond to a predefined interval of time. For example, the oldest 30 minutes or hour of data may be deleted when such a determination is made. It should be noted that smaller or larger intervals of time may also be used. If it is determined that the hard drive is not full or does not contain the predefined quantity of data, the data is recorded to hard drive 52 as indicated by record step 42.

The computer in receiver 16 also has a means for detecting whenever the external memory unit is plugged into data port 22, as indicated by detect USB step 48. If an external memory unit is detected, the computer looks to see if the external memory unit has a security key as indicated by detect key step 46. The security key authenticates that the external memory unit is an authorized device for receiving data from receiver 16. Once the computer validates that an external memory unit is authorized, the computer downloads the data stored in hard drive 52 to the external memory unit as indicated by download step 44. The computer also deletes the data from hard drive 52 during or after transfer of the data to the external memory unit as indicated by delete step 50.

The operations illustrated in FIG. 4 may be directed and controlled by software or firmware in receiver 16. The reader will note that data compression need not involve a separate piece of hardware. The compression and encoding may be controlled by the same software of firmware that controls the other operations of the system. This allows for greater data security and makes the device very easy to use. Unlike conventional surveillance systems which record data to a tape or other removable storage medium, the present invention stores data to a hard drive. Once stored to the hard drive, the data cannot be deleted unless the user has an external memory unit with the appropriate security key. Microphone 14, video camera 12, and receiver 16 are preferably installed in such a manner that the security system cannot easily be detected. This further reduces the risk that a thief, hijacker, or kidnapper would discover the security system. Because the preferred system transmits a live feed wirelessly, a record of the data may also be kept on a remote system. This is particularly useful if the receiver is destroyed or cannot otherwise be recovered.

The preceding description contains significant detail regarding the novel aspects of the present invention. It should not be construed, however, as limiting the scope of the invention but rather as providing illustrations of the preferred embodiments of the invention. As an example, the external memory unit need not be USB compatible. Likewise, data port 22 can be any type of port suitable for transferring data from hard drive 52 to the external memory unit. Such a variation would not alter the function of the invention. Thus, the scope of the invention should be fixed by the following claims, rather than by the examples given.

Having described my invention, I claim:

1. A security system for monitoring activities occurring within a vehicle comprising:
a. a video camera, positioned to monitor said activities occurring within said vehicle;
b. a receiver, said receiver configured to receive video data transmitted from said video camera, said receiver including
i. a hard drive;
ii. a first recording means configured to record said video data to said hard drive;
iii. a data port electronically connected to said hard drive;
iv. a transmitter configured to wirelessly transmit said video data;
c. an external memory unit configured to connect to said data port;
d. an external memory unit detecting means configured to detect whenever said external memory unit is connected to said data port; and
e. a second recording means configured to record said video data contained in said hard drive to said external memory unit when said external memory unit is connected to said data port.

2. The security system of claim 1, further comprising a microphone, said microphone configured to transmit sound data to said receiver.

3. The security system of claim 1, wherein said external memory unit further comprises a security key.

4. The security system of claim 1, further comprising a memory deleting means, said memory deleting means configured to delete a portion of said video data whenever said hard drive contains a predefined quantity of video data.

5. The security system of claim 1, further comprising a memory deleting means, said memory deleting means configured to delete a portion of said video data whenever said video data is recorded to said external memory unit.

6. The security system of claim 1, said receiver further comprising software or firmware directing said receiver to delete a portion of said video data whenever said hard drive contains a predefined quantity of video data.

7. The security system of claim 1, wherein said external memory unit detecting means comprises software of firmware.

8. A security system for monitoring activities occurring within a vehicle comprising:
a. a video camera, positioned to monitor said activities occurring within said vehicle;
b. a receiver, said receiver configured to receive video data transmitted from said video camera, said receiver including
i. a hard drive;
ii. a first recording means configured to record said video data to said hard drive;
iii. a data port electronically connected to said hard drive;
c. an external memory unit configured to connect to said data port;
d. an external memory unit detecting means configured to detect whenever said external memory unit is connected to said data port; and
e. a second recording means configured to record said video data contained in said hard drive to said external memory unit when said external memory unit is connected to said data port.

9. The security system of claim 8, said receiver further comprising a transmitter configured to wirelessly transmit said video data.

10. The security system of claim 8, further comprising a microphone, said microphone configured to transmit sound data to said receiver.

11. The security system of claim 8, wherein said external memory unit further comprises a security key.

12. The security system of claim 8, further comprising a memory deleting means, said memory deleting means configured to delete a portion of said video data whenever said hard drive contains a predefined quantity of video data.

13. The security system of claim 8, further comprising a memory deleting means, said memory deleting means configured to delete a portion of said video data whenever said video data is recorded to said external memory unit.

14. The security system of claim 8, said receiver further comprising software or firmware directing said receiver to delete a portion of said video data whenever said hard drive contains a predefined quantity of video data.

15. The security system of claim 8, wherein said external memory unit detecting means comprises software of firmware.
